(19) United States
(12) Patent Application Publication
(10) Pub. No.: US 2017/0061442 A1
(43) Pub. Date: Mar. 2, 2017

(54) SERVICE TRACKING AND PROVISIONING USING BEACONS

(71) Applicants: Sunny Leigh Barlow, Athens, GA (US); Ferdinand Salarda Acedera, Cebu City (PH); Debbie Sue Ellis, Athens, GA (US); Jeanne Herzog, Athens, GA (US); Hyun Kim, Maitland, FL (US); Kyle Alexander King, Bogart, GA (US); Joseph Jover PIÑON Mendoza, Cebu (PH); Robyn Cortes Zambo, Cebu (PH)

(72) Inventors: Sunny Leigh Barlow, Athens, GA (US); Ferdinand Salarda Acedera, Cebu City (PH); Debbie Sue Ellis, Athens, GA (US); Jeanne Herzog, Athens, GA (US); Hyun Kim, Maitland, FL (US); Kyle Alexander King, Bogart, GA (US); Joseph Jover PIÑON Mendoza, Cebu (PH); Robyn Cortes Zambo, Cebu (PH)

(21) Appl. No.: 14/837,481

(22) Filed: Aug. 27, 2015

(51) Int. Cl. G06Q 30/00; H04W 4/00; H04W 4/02; G06Q 50/12

(52) U.S. Cl. CPC G06Q 30/016; G06Q 50/12; H04W 4/008; H04W 4/021

(57) ABSTRACT

Service tracking using beacons may include receiving, at a computing device including a processor, a plurality of beacon identifiers from a plurality of beacons. Each of the plurality of beacon identifiers may be associated with a unique beacon that may be located at a fixed location on a property. The plurality of beacons may form a matrix of beacons. Once the beacon identifiers are received, the computing device may determine a location of the computing device within the matrix of beacons. The location may include a proximity to one of the plurality of beacons. Once the location of the computing device is determined transmit a service request that may be associated with a service selection may be transmitted to a remote computing device. The service request may include service data for performing the service and the location of the computing device within the matrix of beacon.

### BACKGROUND

Providing service to customers generally requires that the customer's location be known. However, this can be difficult in certain establishments. Further, it is common in many businesses for a small percentage of customers to be the most profitable. Identification of these customers and providing them service is therefore a goal. To provide these most profitable customers service, their locations are also needed. Previous efforts have included the use of customer identification cards that may be read by devices, such as card readers. However, cards are often not carried, may rely on the customer to present his or her card, and deployment of additional networked devices to read the cards.

### SUMMARY

Systems and methods for service tracking and provisioning using beacons may include receiving, at a computing device including a processor, a plurality of beacon identifiers from a plurality of beacons. Each of the plurality of beacon identifiers may be associated with a unique beacon that may be located at a fixed location on a property. The plurality of beacons may form a matrix of beacons. Once the beacon identifiers are received, the computing device may determine a location of the computing device within the matrix of beacons. The location may include a proximity to one of the plurality of beacons. Once the location of the computing device is determined, the computing device may transmit a service request that may be associated with a service selection to a remote computing device. The service request may include service data to perform the service and the location of the computing device within the matrix of beacon.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows an operating environment for service tracking using beacons consistent example embodiments disclosed herein;

FIGS. 2A and 2B show examples of a matrix of beacons consistent with example embodiments disclosed herein;

FIG. 3 shows an example schematic of a computing device consistent with example embodiments disclosed herein; and

FIG. 4 shows an example flowchart for a method of service tracking using beacons consistent with example embodiments disclosed herein.

Corresponding reference characters indicate corresponding parts throughout the several views. The exemplifications set out herein illustrate exemplary embodiments of the invention, and such exemplifications are not to be construed as limiting the scope of the invention any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit the disclosure. Instead, the proper scope of any invention disclosed herein is defined by the appended claims.

Visitors at various establishments such as hotels, casinos, retail establishments, etc. utilize a variety of services. These services may involve interaction with many different people and may only be available at various locations. In other words, unless a customer is at a location with staff at the location or can communicate direct with staff, a service desired by the user may not be available when the customer desires the service. For example, if a customer is by a pool at a hotel, the customer has to wait on hotel staff to come and take the customer's order or the customer has to go and find hotel staff.

A matrix of beacons can allow a customer's location to be determined and services provided to the customer without the customer having to wait for staff or seek out staff. The customer can use a mobile device to request services from the comfort and convenience of the customer's location. Because the customer's location within the matrix of beacons is known, or can be determined, the staff at the property can deliver the service to the customer quickly.

In addition, an application on the customer's mobile device can allow for the creation of a user profile. The user profile can store various information about the customer and allow staff to customize services and products to the customer. For example, a player in a casino may like a certain drink while he or she plays a particular game. Using the information in the user profile, staff at the casino can deliver the drink to the player shortly after he or she arrives at the game.

In addition, managers of properties can use mobile devices to track both customers and employees. Tracking customers may allow the property managers to gain feedback as to what services and products offered by the property customers actually utilize and enjoy and determine which services and products may not add value to customers. In addition, by tracking employees, property managers can gain insight into worker routines as well as monitor performance and efficiencies. The location of customers and employees, sometimes referred to as users throughout this disclosure, may be determined by receiving identification information from various beacons located throughout a property. In other words, a mobile device that receives the identification information from various beacons can use the identification information along with mapping information about the location of each beacon to determine a location of the mobile device. Or more simply, when the mobile device knows it is near a specific beacon or cluster of beacons because the mobile device received identification from the specific beacon or cluster of beacons with known locations, then the mobile device can determine its location.

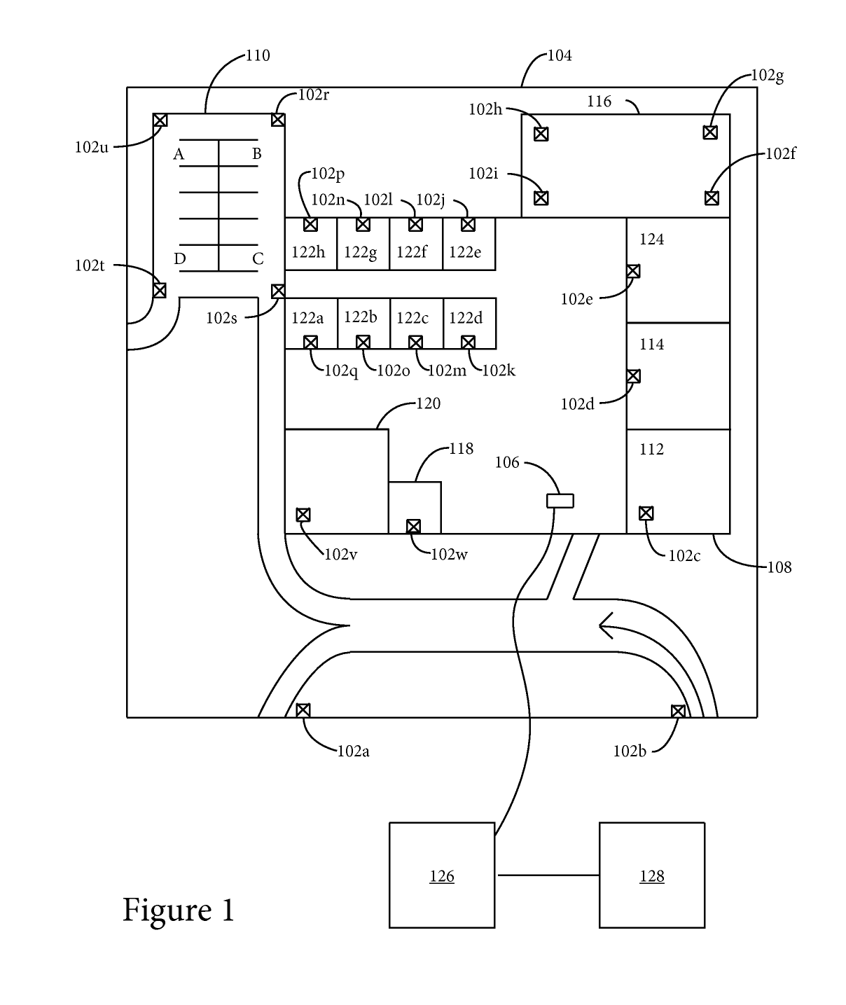

FIG. 1 shows an operating environment 100 for service tracking using beacons. As shown in FIG. 1, a plurality of beacons 102 (individual beacons denoted with a unique letter (e.g., 102a, 102b, . . . 102w) may be placed at fixed locations about a property 104. A user may utilize a mobile device 106 while at the property 104. The mobile device 106 may include an application, or app, and a receiver that allows the mobile device 106 to receive signals from the plurality of beacons 102. The signals may include a beacon identifier. Each of the beacons 102 may transmit a signal that contains a unique beacon identifier.

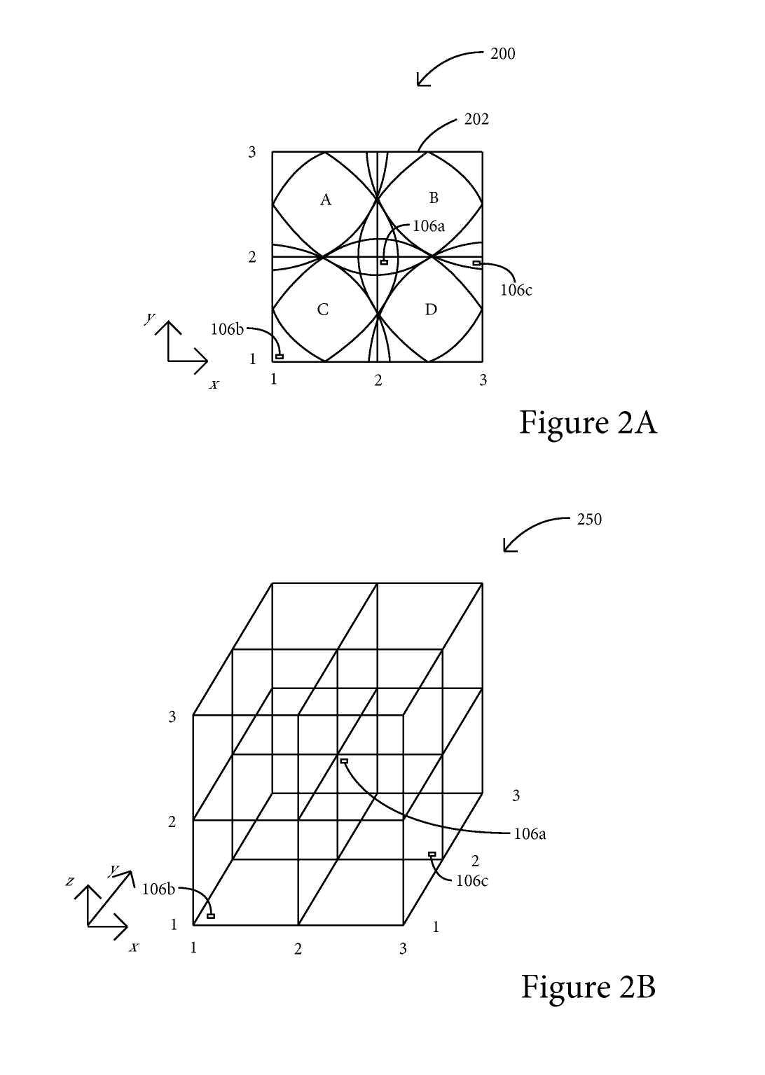

The app on the mobile device 106 may include a property profile. The property profile may include a mapping of each of the beacons 102 to respective locations on the property 104. In addition, the property profile may include a mapping of each of the beacon identifiers to each of beacons 102. As described below with regards to FIGS. 2A and 2B, using the mapping data, the mobile device 106 is enabled to determine a location of mobile device 106.

Utilizing the location, various services can be made available to a user of the mobile device 106. For example, upon arrival at the property 104, the mobile device 106 may detect a user's arrival by receiving a signal from beacon 102b. The mobile device 106 may use past information when determining a current location of mobile device 106. For example, the mobile device 106 may not have received any prior signals from beacons 102 and thus, upon first detecting a signal from beacon 102b, the mobile device 106 may determine that the user, and the mobile device 106, are arriving at the property 104.

Upon arrival at the property 104, the mobile device 106 may automatically check a user into a hotel 108 located on the property 104. In addition, should the user park his or her automobile in the parking lot 110, various signals may be received from beacons 102r, 102s, 102t, and 102u. Using the various signals, the app on the mobile device 106 may record an approximate location of the user's automobile. For example, if the mobile device 106 only receives a signal from the beacon 102u, then the mobile device 106 may record that the user's automobile is parked in section A of parking lot 110. If the mobile device receives signals from beacons 102r, 102s, 102t, and 102u, the mobile 106 device may record that the user's automobile is parked near the center of parking lot 110. Recording the approximate location may assist the user in finding his or her automobile later and assist property personnel in differentiating between automobiles that are authorized to park within the parking lot 110 and those that are not.

As the user progresses about property 104, his or her location may be tracked as the mobile device 106 receives signals from various beacons 102. By tracking the user's location hotel staff may be able to customize services for the user. For example, staff at the front door and at reception area 112 may be notified of the user's arrival on their own mobile devices or via another device or system to enable greeting the user by name. In addition, the user may be able to bypass reception area 112 because mobile device 106 may automatically check the user into hotel 108 upon detecting the user's arrival.

Hotel 108 may have various amenities such as a restaurant 114, a pool 116, a bar 118, a casino 120, and various hotel rooms 122. In addition, hotel 108 may include areas, such as a kitchen 124, that are for employees only. By tracking the user via mobile device 106, the hotel may determine which products and services the user prefers. For example, if the user spends a lot of time at the pool 116, the app on mobile device 106 may provide the user with coupons or other advertisements that may prompt the user to spend money while at the pool 116. In addition, if the user should become lost or otherwise end up in a location that is for staff only, such as the kitchen 124, the app on mobile device 106 may alert the user. The app may prompt the user for a desired location and then provide directions to the desired location. With use of the beacons 102, the mobile device 106 may provide turn by turn directions to the user to ensure the user reaches the desired location.

In addition, to tracking visitors to hotel 108, management may issue mobile devices, such as mobile device 106 to staff. Using mobile devices issued to staff may allow management to monitor staff movements and increase security. For example, hotel staff may monitor housekeepers and maintenance staff. By monitoring housekeepers management may determine an average time for housekeepers to clean rooms and know which housekeepers were in various rooms 122. For example, if a particular housekeeper has been in a single room, e.g., room 122h, for an extended period of time, management may send additional staff to make sure the housekeeper is OK and to offer assistance cleaning what may be an overly dirty room. Additionally, should a hotel guest request assistance or service at a particular location, locations of hotel staff may be quickly viewed and a staff member in closest proximity may be identified and instructed to provide the hotel guest the requested assistance or service, thereby lessening wait time and helping ensure a positive hotel guest experience.

In addition, the app may allow customers to signal a need for security. Because mobile device 106 tracks the user's location, if the user is in distress, the user may press an in-app “panic button” to alert hotel security. For example, a user may notice suspicious activity while at the pool 116 or a swimmer in distress and may alert hotel staff via the mobile device 106.

The mobile device 106 may also allow a user access to his or her room without having to use traditional keys (mechanical or keycards). For example, when a user is within a given proximity (e.g. 10 feet) of his or her hotel room, mobile device 106 may communicate with a beacon located in the hotel room. The user may then be able to press a button on mobile device 106 to unlock the hotel room, which causes a signal to be transmitted from the mobile device 106 to a door lock of the hotel room either directly from the mobile device 106 or indirectly via a process that executes on a network server. In addition, because mobile device 106 may know that the user is in his or her room, the mobile device 106 may push a notification to housekeeping and other hotel staff. The notification may include information, such as information pulled from a user profile, that the user does not like to be disturbed. Thus, housekeeping may avoid disturbing the user. Similarly, when a determined user location is outside of the hotel room, a signal may be sent to housekeeping informing them of the user's departure and an opportunity to service the hotel room while the user is away.

Upon a user finishing his or her stay at hotel 108, the app on the mobile device 106 may automatically check the user out upon detecting the user's departure. For example, on the last day a user has a reservation for the hotel 108, the mobile device 106 may track and note a time when the mobile device 106 passes a beacon that would signify leaving property 104 (e.g., beacons 102a, 102s, or 102t). Once the mobile device 106 has passed such a beacon, the mobile device 106 may transmit a signal via a network 126 to a remote computing device 128 operated by the hotel 108 to check the customer out. The network 126 and the remote computing device 128 may also be utilized when checking the customer into the hotel 108. Furthermore, the network 126 may be used to allow the mobile device 106 and the remote computing device 128 to communicate in order to allow hotel staff to provide services to a user. For instance, when a user wants to order room service or food while at the pool 116, the app on the mobile device 106 may transmit the order to the hotel staff via the network 128. Note that remote computing device 128 may be located on property 104 or may be offsite.

The mobile device 106 and the beacons 102 may communicate via various connections protocols. For example, beacons 102 may be BLUETOOTH® beacons, WI-FI® hotspots, routers, etc. that allow mobile device 106 to relay information to the remote computing device 128, such as unique identifiers of the beacons 102 from which the mobile device 106 has received signals. Non-limiting examples of the network 128 include the Internet, a local area network, a wide area network, and the like.

In addition, GPS receivers within mobile device 106 may also allow the mobile device 106 to determine its location. Furthermore, geofences, created by property managers can be used to determine a user's arrival at the property 104. The use of GPS and geofences may allow property management to provide offers to users. For example, GPS can be used to determine a user's proximity to the property 104 and to local businesses that have partnered with property 104. Thus, when users are away from the property 104, the app on the mobile device 106 may provide the user with coupons, advertisements, or other offers for businesses located nearby.

As an example, a user may be on vacation or traveling for business. The user may have a user profile associated with the property 104. The user profile may indicate that the user likes seafood or is a vegetarian. The user profile as to food preferences, or any other preferences, may be input by the user or determined by the mobile device 106 or service that executes on a server based on past behaviors. For example, the user's food preferences may be determined based on past room service or restaurant orders. Using the preference information, the mobile device 106 may determine, using GPS or beacons installed at a partnering business that the mobile device 106 is near a seafood or vegetarian restaurant located near property 104. Based on the determination, mobile device 106 may provide the user with coupons or other reward points for visiting the partnering business.

FIG. 2A shows a two-dimensional matrix of beacons 200. For clarity, the matrix of beacons 200 is simplified and shown as a 3,3 matrix. However, various embodiments may include a matrix of X,Y size. In addition, while FIG. 2A shows the beacons having a uniform spacing, the spacing of the various beacons can vary.

In FIG. 2A, the intersection of any two straight lines represents a beacon_{x,y}. Beacon_{x,y} could be located in a hotel room. In addition, each of the beacons could represent a location within an area 202. For the purposes of discussing FIG. 2A, area 202 will be described in the context of a casino and the intersection of the straight lines represents a beacon located a gaming table.

Each of the beacons within the matrix of beacons 200 may have a known transmission range. For example, the signal transmitted by each beacon may only be receivable by a mobile device if the mobile device is within 10 ft. of the beacon. In addition, the property profile for property 104 may include a mapping of each beacon 102 to a location as well as a transmission range. For example, for each of the beacons 200, the property profile may include the beacon identifier, the location of the beacon, and additional information such as a game associated with each beacon and betting minimums for each game.

The matrix of beacons 200 can be used to determine a location of mobile devices 106a, 106b, and 106c. For example, the mobile device 106a may receive a beacon identifier from the matrix of beacons 200, such as beacons 102_{2,2}, 102_{1,2} 102_{3,2} 102_{2,3} and 102_{1,2}. With the beacon identifiers, the app on the mobile device 106a can determine that the mobile device 106a is proximate the beacon 102_{2,2} because the other beacons 102_{1,2}, 102_{3,2}, 102_{2,3}, and 102_{1,2} surround the beacon 102_{2,2}. Stated another way, mobile device 106a can determine that the beacon 102_{2,2} is approximately in the center of all the beacons from which mobile device 106a receives a beacon signal.

For a mobile device that is near an edge of matrix of beacons 200 (e.g., mobile device 106b), a location can be determined even though the mobile device 106b may not be in a center of a plurality of beacons. As shown in FIG. 2A, the mobile device 106b may be proximate the beacon 102_{1,1}. As such, mobile device 106b may receive signals from beacons 102_{1,1}, 102_{2,1}, and 102_{1,2}. Because the mobile device 106b is not receiving signals from the beacon 102_{2,2} the mobile device 106b can determine that the mobile device 106b is not proximate beacon 102_{2,2} and based on the signals received, the probability that the mobile device 106b is proximate beacon 102_{1,1} would be higher than the mobile device 106b being proximate any other beacon.

In another example, the mobile device 106c may be proximate the beacon 102_{3,2}, and receive signals from the beacons 102_{3,2}, 102_{3,1}, 102_{2,2}, and 102_{3,3}. Because the mobile device 106c is receiving signals from beacons 102_{3,1} and 102_{3,3} the mobile device 106c can determine that it is between beacons 102_{3,1} and 102_{3,3} (i.e., near beacon 102_{3,2}). Because the mobile device 106c is not receiving signals from beacon 102_{2,1}, 102_{2,3}, or 102_{1,2} the mobile device 106c can determine that it is closer to beacon 102_{3,2} than beacon 102_{2,2}.

Simply stated, the various segments created by the circles that represent the radius of transmission for each of the beacons can be mapped to a set of beacons that a signal would be received from in order to be in that location. Table 1 shows a table that may represent the mapping of signals received from beacons to a proximate location. For example, for a location proximate beacon 102_{1,1}, a mobile device may receive signals from beacon 102_{1,1}, 102_{2,1} and 102_{1,2.}

Other combinations of beacon signals received may correspond to walkways or other floor space in the casino that spectators stand while watching other play. For example, if a mobile device receives signals from beacons 102_{1,2}, 102_{2,2}, 102_{1,3}, and 102_{2,3}, which is not a pairing shown in Table 1, the mobile device may be in Section A of area 202. Received beacons signals that would correspond to sections A, B, C, and D of area 202 can also be mapped in Table 1. Because sections A, B, C, and D correspond to areas where people are not gambling they may be considered low value areas to the casino and thus not mapped in as great as detail as the areas corresponding to games.

TABLE 1
Beacon to Location Mapping

| Location | Game | Signals Received from Beacons: |
|---|---|---|
| 102_{1,1} | $5 Blackjack | 102_{1,1}, 102_{1,2}, and 102_{2,1} |
| 102_{1,2} | $5 Blackjack | 102_{1,2}, 102_{1,1}, 102_{1,3}, and 102_{2,2} |
| 102_{1,3} | $5 Roulette | 102_{1,3}, 102_{1,2}, and 102_{2,3} |
| 102_{2,1} | $25 Blackjack | 102_{2,1}, 102_{1,1}, 102_{3,1}, and 102_{2,2} |
| 102_{2,2} | $100 Craps | 102_{2,2}, 102_{2,1}, 102_{3,2}, 102_{2,3}, and 102_{1,2} |
| 102_{2,3} | $25 Roulette | 102_{2,3}, 102_{2,2}, 102_{1,3}, and 102_{3,3} |
| 102_{3,1} | $10 Blackjack | 102_{3,1}, 102_{2,1}, and 102_{3,2} |
| 102_{3,2} | $10 Roulette | 102_{3,2}, 102_{3,1}, 102_{2,2}, and 102_{3,3} |
| 102_{3,3} | $10 Craps | 102_{3,3}, 102_{3,2}, and 102_{2,3} |

In some other embodiments, strength of signals received from the beacons 102_{1,1}, 102_{2,1}, and 102_{1,2} may be utilized to determine an approximate distance from each respective beacon 102_{1,1}, 102_{2,1}, and 102_{1,2} and a triangulation algorithm may be applied to those distances from the known beacon 102_{1,1}, 102_{2,1}, and 102_{1,2} locations to determine an approximate location of the mobile device 106b.

If remote computing device 128, executing a process for tracking casino patrons and employees, determines that a person stays in one of Sections A, B, C, or D for a long period, remote computing device 128 may forward a voucher to the user to encourage him or her to play a game present in respective section. For example, if a person remains in Section A for a given time, remote computing device 128 may forward him or her a match play voucher where the casino matches a wager placed by the person for a single spin of the roulette wheel that is present in Section A.

FIG. 2B shows an example of a three-dimensional matrix of beacons 250 consistent with example embodiments disclosed herein. For clarity, matrix of beacons 250 is simplified and shown as a 3,3,3 matrix. However, various embodiments may matrix of X,Y,Z size. In addition, while FIG. 2B shows the matrix of beacons 250 having a uniform spacing, the spacing of the various beacons can vary. For example, in a multi-floor hotel, many of the floors with hotel rooms may have the same or similar floorplans. As a result, beacons within the hotel rooms may form an orderly grid, such as shown in FIG. 2B. On the ground floor, the beacons may form a non-orderly grid.

Each of the beacons within matrix of beacons 250 may have a known transmission range and signal strength. For example, the signal transmitted by each beacon may only be receivable by a mobile device if the mobile device is within 20 feet of the beacon. As described above with reference to FIG. 2A, strength of signals received from the beacons 102 may be utilized to determine an approximate distance from each respective beacon 102 and a triangulation algorithm may be applied to those distances from the known beacon 102 locations to determine an approximate location of the mobile device 106. In addition, the property profile for property 104 may include a mapping of each beacon to a location as well as a transmission range and signal strengths for various locations proximate each beacon.

In some embodiments, the location may be adjusted based on a signal strength of one or more received beacon signals, such as to determine a likely distance form one or more beacons 102 from which a beacon signal has been received by the mobile device 106. In some such embodiments, various triangulation algorithms may be applied to one or more of the beacon signals, their signal strengths, and determined distances from the beacons 102 to determine a position with relative accuracy. For example, based on a signal strength from a single beacon, a proximate distance of 30 feet or less from the single beacon can be determined as a typical BLUETOOTH® signal has a maximum range of approximately 30 feet. However, when the signal strength is less than 100 percent, the distance can be determined to be in the outer ranges of the 30 feet. But when the signal strength is high, the distance from the beacon 102 can be determined to be in the inner ranges of 30 feet, such as maybe five to ten feet, depending on the signal strength. Based on determined distances from a plurality of beacons 102, such as five feet from a first beacon 102, fifteen feet from a second beacon 102, and twelve feet from a third beacon 102, accuracy of a determined position can be quite high. Note however that environmental factors can impact beacon signal strength, such as when a beacon 102 is deployed at a location near a large, metal object that might absorb electromagnetic waves broadcast by a radio transceiver of a beacon 102. Thus, some embodiments include an environmental tuning process that is performed to apply signal strength multipliers to the location determining process, either to increase or decrease a signal strength, to account for such environmental factors.

The matrix of beacons 250 can be used to determine a location of mobile devices 106a and 106b. For example, the mobile device 106a may receive a beacon identifier from a plurality of beacons, e.g., beacon 102_{2,2,2}, 102_{1,2,2}, 102_{2,2,3}, 102_{2,3,2}, 102_{3,2,2}, 102_{2,2,1}, and 102_{2,1,2}. With the beacon identifiers the app on mobile device 106a can determine that the mobile device 106a is proximate the beacon 102_{2,2,2} because the other beacons 102_{1,2,2}, 102_{2,2,3}, 102_{2,3,2}, 102_{3,2,2}, 102_{2,2,1}, and 102_{2,1,2} surround beacon 102_{2,2,2}. Stated another way, the mobile device 102a can determine that beacon 102_{2,2,2} is in the proximate a center of all the beacons 102 from which the mobile device 102a receives a beacon signal. In addition, using the signal strength data, approximate distances from the know beacon location of beacons 102 from which mobile device 102a receives a beacon signal can be determined.

For a mobile device that is near an edge of the matrix of beacons 250 (e.g., mobile device 102b), a location can be determined even though the mobile device 106b may not be in a center of a plurality of beacons. As shown in FIG. 2B, the mobile device 106b may be proximate the beacon 1021,1,1. As such, the mobile device 106b may receive signals from the beacons 102_{1,1,1}, 102_{1,2,1}, 102_{2,1,1}, and 102_{1,1,2}. Because the mobile device 106b is not receiving signals from the beacon 102_{2,2,2} the mobile device 106b can determine that the mobile device 106b is not proximate the beacon 102_{2,2,2} and based on the signals received, the probability that the mobile device 106b is proximate the beacon 102_{1,1,1} would be higher than the mobile device 106b being proximate any other beacon.

In another example, the mobile device 106c may be proximate the beacon 102_{3,2,1}, and receive signals from the beacons 102_{3,2,1}, 102_{2,2,1}, 102_{3,1,1}, 102_{3,3,1}, and 102_{3,2,2}. Because the mobile device 106c is receiving signals from the beacons 102_{3,1,1} and 102_{3,3,1} the mobile device 106c can determine that it is between the beacons 102_{3,1,1} and 102_{3,3,1} (i.e., near beacon beacons 102_{3,2,1}). Because the mobile device 106c is not receiving signal from the beacon 102_{3,2,3}, the mobile device 102c can determine that it is closer to the beacon 102_{3,2,1} than the beacon 102_{3,2,2}.

In addition, additional location assistance information can be used to help determine a location of mobile devices. For example, various signals from GPS satellites can be used in conjunction with signals from the beacons to determine a location. For example, when at least four signals are received from GPS satellites an elevation can be determined. Thus, the property profile may include elevation information and once an elevation of a mobile device is determined, an elevation within the matrix of beacons can be determined.

Because each beacon transmits in an omnidirectional manner a sphere may be created about the beacon where a signal can be received. Simply stated, the location of a mobile device may be at the intersection of all the spheres created by the broadcasting beacons.

Once a mobile device determines which beacon it is proximate, the mobile device can consult a table that maps the beacon to a location. Table 2 shows a mapping of beacons to locations. In addition, groupings of signals received can be mapped as described above with regard to Table 1.

TABLE 2
Mapping of Beacons to Locations

| Beacon | Location |
|---|---|
| 102c | Reception 112 |
| 102d | Restaurant 114 |
| 102e | Kitchen 124 |
| . . . | . . . |
| 102w | Bar 118 |
| . . . | . . . |

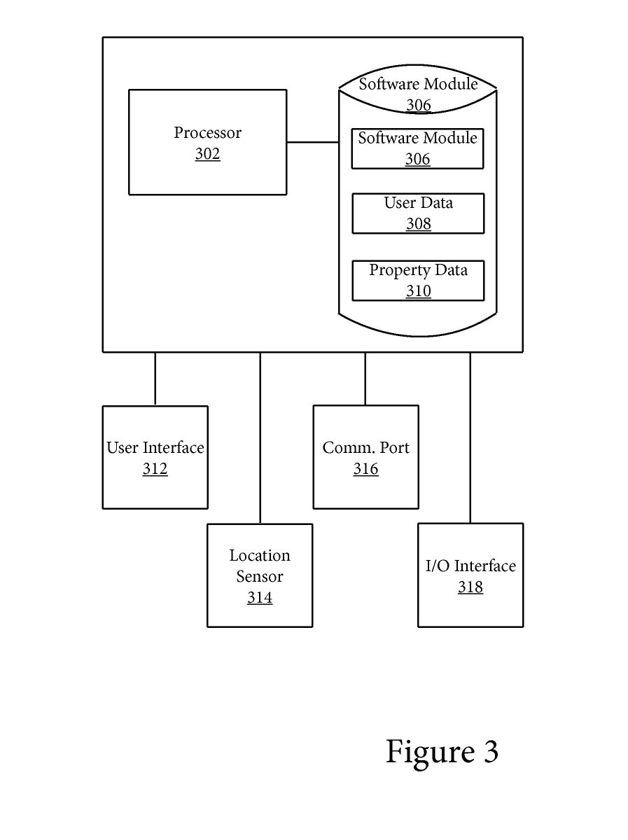

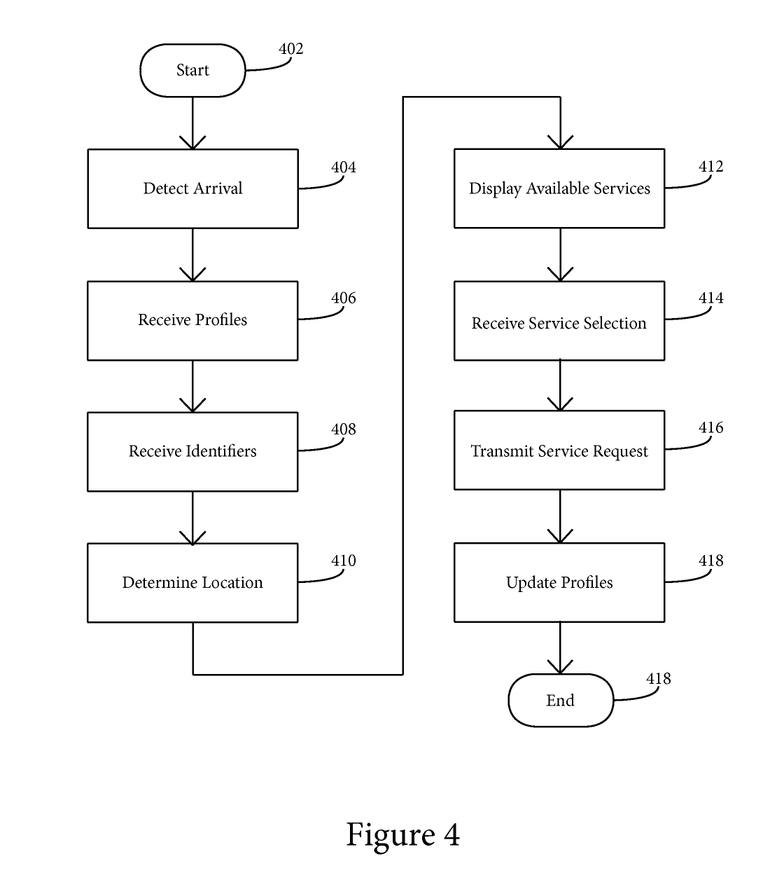

FIG. 3 shows an example schematic of a computing device 300. Computing device 300 may represent the mobile device 106 or the remote computing device 128. As shown in FIG. 3, the computing device 300 may include a processor 302 and a memory unit 304. The memory unit 304 may include a software module 306, user data 308, and property data 310. While executing on the processor 302, the software module 204 may perform processes for selecting and making a payment, including, for example, one or more stages included in method 400 described below with respect to FIGS. 4.

The user data 308 may include a user profile. The user profile may be created by a user or an operator of the remote computing device 128 or the property 104. The user profile may include data representing user preferences and billing information. For example, the user profile may include, but is not limited to, room preferences such as non-smoking, king sized or double beds, floor preferences, proximity to elevator preferences, room service preferences, early check-in/late check-out preferences and privileges, gambling preferences, restaurant and shopping preferences, etc. The billing information may include, but is not limited to, credit card information, banking information, billing address, etc.

In addition, the user profile may be updated by the user or the operator of the remote computing device 128 or the property 104. For example, after each stay at a property, such as the property 104, the user may update his or her profile to indicate desired rooms, bed size preference, etc. In addition, after a visit to a property, such as the property 104, the operator of the remote computing device 128 or the property 104 may update the user profile. For example, during a visit a user may gamble at a certain table and bet, on average, a given dollar amount. Thus, the user profile can be updated by a casino to reflect the user's gambling habits.

The property data 310 can include a mapping of beacons, such as the matrix of beacons 200 and 250, and locations as described above. In addition, property data can include a listing of services that are available at given locations. For example, when a user is near the pool 116, a user may be able to order room service that is delivered at the pool. When a user is in or near the room 122a, he or she may be able to unlock the door, order room service, request a wakeup call, request housekeeping, and indicate a “do not disturb” status to housekeeping.

The computing device 300 may also include a user interface 312. The user interface 312 can include any number of devices that allow a user to interface with the computing device 300. Non-limiting examples of the user interface 312 include a keypad, a microphone, a display (touchscreen or otherwise), etc.

The computing device 300 may also include a location sensor 314. The location sensor 314 can include any number of devices that provides information to allow the computing device 300 to determine its location. A non-limiting example of the location sensor 314 includes a GPS receiver.

The computing device 300 may also include a communications port 316. The communications port 316 may allow the computing device 300 to communicate with the beacons 102 and the remote computing device 128 as described above with regard to FIG. 1. Non-limiting examples of the communications port 316 include, Ethernet cards (wireless or wired), BLUETOOTH® transmitters and receivers, near-field communications modules, etc.

The computing device 300 may also include an input/output (I/O) device 318. The I/O device 318 may allow the computing device 300 to receive and output information. Non-limiting examples of the I/O device 318 include, a camera (still or video), a printer, a scanner, etc.

The computing device 300 may be implemented using a personal computer, a network computer, a mainframe, a handheld device, a personal digital assistant, a smartphone, or any other similar microcomputer-based workstation. The computing device 300 may be located in close proximity to the property 104 as described herein. The computing device 300 may also be remote from the property 104 as described herein. For instance, the computing device 300 can be a smart phone carried by a user at the property 104. The computing device 300 could also be a server located at the property 104. In addition, the computing device 300 may be a server located offsite from the property 104.

FIG. 4 shows an example method 400 for making service tracking using beacons. Method 400 may begin at stage 402 and proceed to stage 404 where a user's arrival can be detected. For example, as a guest approaches the property 104, maybe to stay at the hotel 108 or eat at the restaurant 114, the guest may be have the mobile device 106 in his or her possession. Once within range of the beacon 102b, the mobile device 106 may detect an arrival at the property 104. In addition, the property 104 may include a geofence and once the mobile device 106 crossing a boundary of the geofence, an arrival may be detected.

From stage 404, method 400 may proceed to stage 406 where profiles may be received. For example, upon arrival at the property 104, the mobile device 106 may download a property profile that includes mapping of the beacons 102 to the various locations about property 104. The mobile device 106 may also download a user profile for the user of the mobile device 106 that is specific to the property 104. For instance, various properties may maintain user profiles that can be downloaded when a user is at a property. Not storing all of the profiles on the mobile device 106 may save memory within mobile device 106. In addition, if method 400 is be carried out by the remote computing device 128, the remote computing device 128 may download a user profile associated with the mobile device 106.

From stage 406, method 400 may proceed to stage 408 where identifiers may be received. For example, as a user walks about the property 104, the mobile device 106 may receive signals from various beacons proximate the mobile device 106. Each of the beacon identifiers may be associated with a unique beacon that may be located at a fixed location on the property 104. If method 400 is being implemented by the remote computing device 128, the mobile device 106 may transmit the beacon identifiers it receives to the remote computing device 128.

From stage 408, method 400 may proceed to stage 410 where a location of the mobile device 106 may be determined. The location of the mobile device 106 may be determined by the mobile device 106 as described above with regards to FIGS. 2A and 2B. Furthermore, the beacon information may also be supplemented by GPS data received via the location sensor 314. Remote computing device 128 may also determine the location of the mobile device 106 using beacon data received from the mobile device 106 when method 400 is implemented on remote computing device 128.

From stage 410, method 400 may proceed to stage 412 where a list of services may be displayed. For example, for a given location, certain services may be available and certain services may not be available. For instance, if the mobile device 106 is located near a user's hotel room, a service such as unlocking the hotel room door may be available, and if the mobile device 106 is near the pool 116 the service of unlocking the hotel room door may not be available.

The property profile may include the mapping of beacons to services. Thus, once a proximity to a specific beacon (i.e., the location of the mobile device 106), the available services can be selected from the property profile and displayed on the user interface 312.

In the context of tracking employees or other staff at the property 104, the list of services could be a task for an employee or staff to perform. For example, a user could be using remote computing device 128 and receive the location of the mobile device 106. Remote computing device 128 could display a lists of tasks for the staff member to perform near or at the location. For instance, a maintenance person proximate a hotel room, may have a task to repair a sink in the hotel room. When maintenance person gets close to the hotel room, the remote computing device 128 may notify a user of the remote computing device 128 by displaying a list of services the maintenance person can perform.

From stage 412, method 400 may proceed to stage 414 where a service selection may be received. For example, a guest at hotel 108 proximate his or her hotel room may select to unlock the door or to order room service. The selection of the service may be received by the mobile device 106. In the context of the maintenance person described above, the user of the remote computing device 128 may make a selection of a service (e.g., repairing a sink in a room) and that selection can be received by the remote computing device 128.

From stage 414, method 400 may proceed to stage 416 where a service request may be transmitted. For example, the guest at the hotel 108 may transmit a room service or housekeeping request to the remote computing device 128. In the context of the maintenance person, the remote computing device 128 may transmit the service request to the mobile device 106.

From stage 416, method 400 may proceed to stage 418 where profiles may be updated. For example, after a user transmits a room service request, the mobile device 106 may update a user profile to reflect food preferences. In the context of the maintenance person, a property profile may be updated to indicate that a particular hotel room is not available due to a maintenance issue. From stage 420, method 400 may terminate at stage 420.

Consistent with embodiments disclosed herein, a method may comprise: receiving, at a computing device including a processor, a plurality of beacon identifiers from a plurality of beacons, determining, by the computing device, a location of the computing device within the matrix of beacons, and transmitting, by the computing device, a service request associated with a service selection to a remote computing device. Each of the plurality of beacon identifiers may be associated with a unique beacon that may be located at a fixed location on a property. The plurality of beacons may form a matrix of beacons. The location may include a proximity to one of the plurality of beacons. The service request may include service data for performing the service and the location of the computing device within the matrix of beacons.

The method may further comprise receiving, by the computing device, a property profile. The property profile may include a mapping of the matrix of beacons to locations about the property.

The property profile may include a list of services that may be associated with each of the plurality of beacons within the matrix of beacons or a combination of beacons.

The method may further comprise displaying, on a display of the computing device, the list of services that may include the service. The list of services may be associated with the one of the plurality of beacons.

The plurality of beacon identifiers may include a BLUETOOTH® beacon identifier or a WI-FI® access point identifier.

The service may include one of checking into a hotel located on the property, unlocking a hotel room, and ordering room service.

The method may further comprise: receiving, at the computing device, a user profile and updating the user profile. The user profile may include data that may be representative of preferences that may be associated with a plurality of properties and services that may be available at the plurality of properties. Updating the user profile may include updating the user profile to include additional preferences that may be associated with the property, the plurality of properties, the services available at the plurality of properties, and the service.

Consistent with embodiments disclosed herein, a system may comprise a processor and a memory. The memory may store instructions that, when executed by the processor, cause the processor to perform operations that may include: receiving a plurality of beacon identifiers from a plurality of beacons, determining a location of a computing device within the matrix of beacons, and transmitting a request associated with a service to a remote computing device. Each of the plurality of beacon identifiers may be associated with a unique beacon that may be located at a fixed location on a property. The plurality of beacons may form a matrix of beacons. The location may include a proximity to one of the plurality of beacons. The request may include data that may be relevant for performance of the service and the location of the computing device within the matrix of beacons. The location of the computing device may be a center of the matrix of beacons.

The operations may further comprise receiving a property profile. The property profile may include a list of beacon identifiers and a list of services. The list of beacon identifiers may be mapped to the matrix of beacons. The list of services may be associated with each of the plurality of beacons within the matrix of beacons. In some embodiments, a property profile may include the signal strength multipliers to account for environmental factors from the tuning process described herein.

The operations may further comprise displaying, on a display of the system, the list of services. The list of services may include the service, the list of services associated with the one of the plurality of beacons.

The operations may further comprise: receiving a user profile and updating the user profile. The user profile may include preferences that may be associated with a plurality of properties and services available at the plurality of properties. Updating the user profile may include updating the user profile to include additional preferences that may be associated with the property that may include the plurality of properties, the services available at the plurality of properties, and the service.

Consistent with embodiments disclosed herein, a method may comprise: receiving, at a computing device including a processor, a plurality of beacon identifiers from a mobile device, determining, by the computing device, a location of the mobile device within the matrix of beacons, and storing, in a memory of the computing device, a time corresponding to a length of time the mobile device remains at the location. The plurality of beacon identifiers may be associated a matrix of beacons.

Determining the location of the computing device within the matrix of beacons may include determining a center beacon within the matrix of beacons. The location being proximate the center beacon.

The method may further comprise transmitting, by the computing device, an alert to the mobile device.

The method may further comprise storing the time and location of the mobile device.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, at a computing device including a processor, a plurality of beacon identifiers from a plurality of beacons, each of the plurality of beacon identifiers associated with a unique beacon located at a fixed location on a property, the plurality of beacons forming a matrix of beacons;
determining, by the computing device, a location of the computing device within the matrix of beacons, the location including a proximity to one of the plurality of beacons; and
transmitting, by the computing device, a service request associated with a service selection to a remote computing device, the service request including service data for performing the service and the location of the computing device within the matrix of beacons.

2. The method of claim 1, wherein the matrix of beacons forms a three-dimensional grid of beacons.

3. The method of claim 1, further comprising receiving, by the computing device, a property profile, the property profile including a mapping of the matrix of beacons to locations about the property.

4. The method of claim 3, wherein the property profile further includes a list of services associated with each of the plurality of beacons within the matrix of beacons.

5. The method of claim 4, further comprising displaying, on a display of the computing device, the list of services including the service, the list of services associated with the one of the plurality of beacons.

6. The method of claim 1, wherein the plurality of beacon identifiers includes a BLUETOOTH® beacon identifier or a WI-FI® access point identifier.

7. The method of claim 1, wherein the service includes one of checking into a hotel located on the property, unlocking a hotel room, and ordering room service.

8. The method of claim 1, further comprising:
receiving, at the computing device, a user profile including data representative of preferences associated with a plurality of properties and services available at the plurality of properties; and
updating, by the computing device, the user profile to include additional preferences associated with the property, the plurality of properties, the services available at the plurality of properties, and the service.

9. A system comprising:
a processor; and
a memory that stores instructions that, when executed by the processor, cause the processor to perform operations including:
receiving a plurality of beacon identifiers from a plurality of beacons, each of the plurality of beacon identifiers associated with a unique beacon located at a fixed location on a property, the plurality of beacons forming a matrix of beacons,
determining a location of a computing device within the matrix of beacons, the location including a proximity to one of the plurality of beacons, and
transmitting a request associated with a service to a remote computing device, the request including data for performing the service and the location of the computing device within the matrix of beacons.

10. The system of claim 9, wherein the matrix of beacons forms a three-dimensional grid of beacons.

11. The system of claim 10, wherein the location of the computing device is a center of the matrix of beacons.

12. The system of claim 9, wherein the operations further comprise receiving a property profile including:
a list of beacon identifiers, the list of beacon identifiers mapped to the matrix of beacons; and
a list of services associated with each of the plurality of beacons within the matrix of beacons.

13. The system of claim 12, wherein the operations further comprise displaying, on a display of the system, the list of services including the service, the list of services associated with the one of the plurality of beacons.

14. The system of claim 9, wherein the plurality of beacon identifiers includes a BLUETOOTH® beacon identifier or a WI-FI® access point identifier.

15. The system of claim 9, wherein the service includes one of checking into a hotel located on the property, unlocking a hotel room, and ordering room service.

16. The system of claim 9, wherein the operations further comprise:
receiving a user profile including preferences associated with a plurality of properties and services available at the plurality of properties; and
updating the user profile to include additional preferences associated with the property, the plurality of properties, the services available at the plurality of properties, and the service.

17. A method comprising:
receiving, at a computing device including a processor, a plurality of beacon identifiers from a mobile device, the plurality of beacon identifiers associated a matrix of beacons;
determining, by the computing device, a location of the mobile device within the matrix of beacons; and
storing, in a memory of the computing device, a time corresponding to a length of time the mobile device remains at the location.

18. The method of claim 17, wherein determining the location of the computing device within the matrix of beacons includes determine a center beacon within the matrix of beacons, the location being proximate the center beacon.

19. The method of claim 17, further comprising transmitting, by the computing device, an alert to the mobile device.

20. The method of claim 17, further comprising storing the time and location of the mobile device.
